(19) United States
(12) Patent Application Publication
(10) Pub. No.: US 2026/0338128 A1
(43) Pub. Date: Oct. 29, 2026

(54) FUELING SYSTEM CONTROLS INCLUDING FUELING RATE SHAPE DETERMINATION

(71) Applicant: Cummins Inc., Columsbus, IN (US)

(72) Inventors: Yash Agarwal, West Sacramento, CA (US); Jalal Shah Syed, Indianapolis, IN (US)

(21) Appl. No.: 19/119,563

(22) PCT Filed: Oct. 3, 2023
(86) PCT No.: PCT/US2023/075867

§ 371 Date: Apr. 9, 2025

(51) Int. Cl. F02D 41/22; F02D 41/38; F02D 41/40; F02M 65/00

(52) U.S. Cl. CPC F02D 41/22; F02D 41/3845; F02D 41/401; F02M 65/001; F02M 65/003; F02D 2041/224; F02D 2200/0606; F02D 2200/0614

(57) ABSTRACT

A process of operating a computing system in operative communication with a fueling system including includes receiving a fueling command including a specified fuel quantity and a specified fuel pressure, determining a first fueling rate shape corresponding to the specified fuel pressure but not corresponding to the specified fuel quantity, determining a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape, updating a fuel metering device control model based on the second fueling rate shape, and at least one of controlling and diagnosing a fuel metering device of the fueling system using the updated fuel metering device control model.

### CROSS REFERENCE

The present application claims priority to and the benefit of U.S. Application No. 63/380,116 filed Oct. 19, 2022, and the same is hereby incorporated by reference.

### TECHNICAL FIELD

The present application relates to fueling system controls including fueling rate shape determination.

### BACKGROUND

Fueling systems for internal combustion engines may include a number of fuel metering devices such as fuel pumps and fuel injectors. Controls for such systems suffer from a number of shortcomings including those respecting accuracy, flexibility, precision, reliability, and robustness, among other shortcomings. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

One embodiment is a unique fueling system controls including fueling rate shape determination. Further embodiments include unique apparatuses, systems, and processes comprising or embodying such controls. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example engine system including an example fueling system.

FIG. 2 is a flow diagram illustrating certain aspects of an example process.

FIG. 3 is a schematic diagram illustrating certain aspects of example controls.

FIGS. 4-7 are graphs illustrating certain aspects of example operations which may be performed in connection with the process of FIG. 2 and implemented in connection with the controls of FIG. 3.

### DETAILED DESCRIPTION OF EXAMPLE EMBODIMENTS

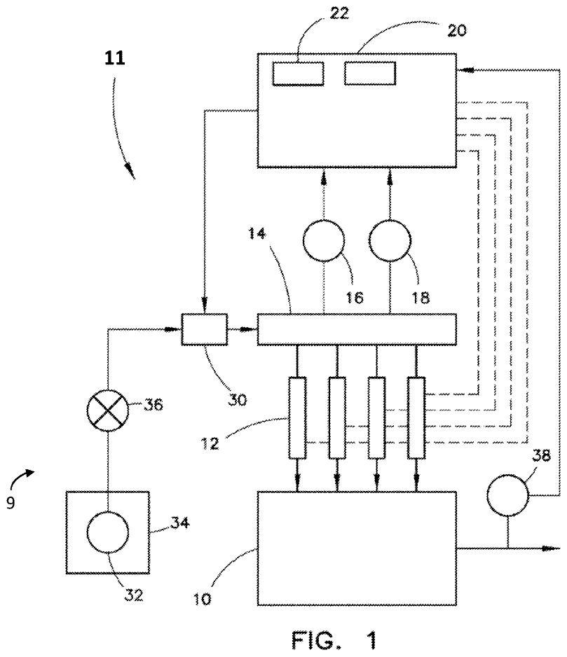

With reference to FIG. 1, there is illustrated a system 11 comprising an engine 10 including a fueling system 9. The engine 10 may be an internal combustion engine, including but not limited to a compression-ignition engine, using diesel or other suitable fuel, or a spark-ignition engine, using gasoline, natural gas, or other suitable fuels. Engine 10 may have one or more combustion cylinders (not depicted) to generate mechanical power from the combustion of a fuel. The fuel injectors 12 are in fluid communication with respective combustion cylinders of the engine 10 and are structured to introduce the fuel into respective combustion cylinders. Though four fuel injectors 12 are depicted in FIG. 1, engine 10 may include fewer or greater numbers of fuel injectors 12. In certain embodiments, engine 10 may include one fuel injector 12 for each cylinder.

In the illustrated embodiment, the fueling system 9 is configured and provided as a high-pressure common-rail fuel injection system including a plurality of fuel injectors 12 in fluid communication with a common fuel rail 14, which supplies fuel at relatively high pressure to each fuel injector 12. Fuel may be supplied to the common fuel rail 14 by a high-pressure pump 30. In certain embodiments, the high-pressure pump may be fed by a relatively low-pressure fuel circuit including a booster pump 32, which may be immersed in a tank 34 containing the fuel. A fuel regulator 36 may control the flow of fuel from tank 34 to the high-pressure pump 30.

System 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include a pressure sensor 16 and a temperature sensor 18. The pressure sensor 16 is in communication with the common fuel rail 14 and structured to communicate a measurement of the pressure within the common fuel rail 14 to the ECS 20. The temperature sensor 18 is in communication with the common fuel rail 14 and structured to communicate a measurement of the temperature within the common fuel rail 14 to the ECS 20. In at least one embodiment, system 11 may include an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the system 11. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any Page 4 of 25 engine system parameter and/or various combinations of such parameters either directly or indirectly.

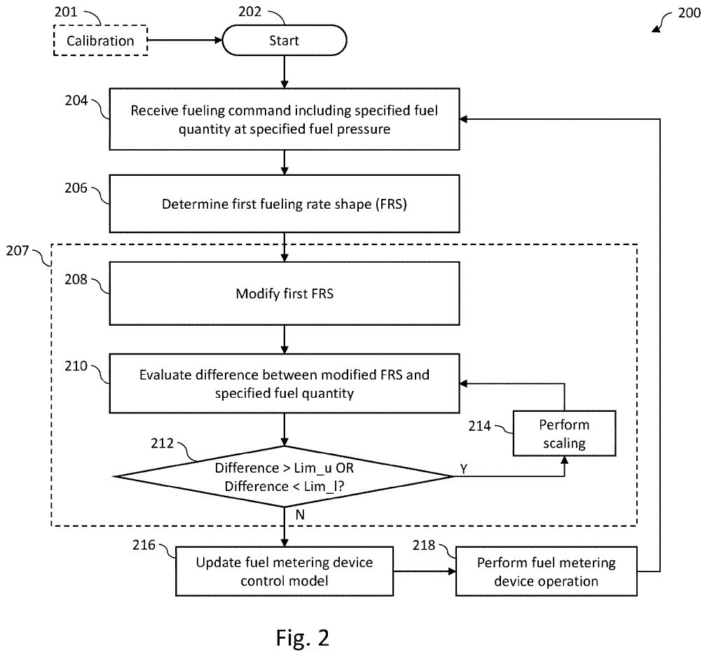

With reference to FIG. 2, there is illustrated an example process 200 for operating a computing system (e.g., ECS 20, another electronic control system, or another computing system) in operative communication with a fueling system (e.g., fueling system 9 or another fueling system). Process 200 may be implemented in and performed by one or more components of a computing system, for example, one or more electronic control modules or other control components of ECS 20, another electronic control system, or another computing system.

Prior to or as a part of the first time that process 200 is performed for a given system (e.g., after system commissioning, calibration, configuration, re-calibration, or service events), a calibration operation 201 may be performed. Calibration operation 201 may establish or store predetermined fueling rate shapes in a non-transitory computer readable memory medium which is readable in connection with the execution or performance of process 200. The predetermined fueling rate shapes may comprise fuel injection rate shapes which may comprise a plurality of values indicating a fuel injection rate (fuel volume injected per unit time) as a function of time. The predetermined fueling rate shapes may comprise fuel pumping rate shape which may comprise a plurality of values indicating a fuel pumping rate (fuel volume pumped per unit time) as a function of time. The predetermined fueling rate shapes may correspond to different predetermined fueling rates and predetermined fueling pressures. In one example embodiment, a first predetermined fueling rate shape corresponding to a maximum fueling amount (e.g., maximum injection amount or maximum pumping amount) at a maximum fuel pressure and a second predetermined fueling rate shape corresponding to the maximum fueling amount at a minimum fuel pressure are determined and/or stored by operation 201.

Once a calibration has been established by operation 201 or otherwise, process 200 will begin at start operation 202 and proceeds to operation 204. Operation 204 receives a fueling command including a specified fuel quantity and a specified fuel pressure. The fueling command may be received in a number of manners including, for example, by a controller receiving as input a fueling command output by another controller, by a controller accessing, reading, storing, or otherwise processing a fueling command stored in a non-transitory computer readable memory medium, or in other manners of receiving, it being appreciated that the aforementioned controllers and non-transitory memory The fueling command, the specified fuel quantity, and the specified fuel pressure may be provided an a plurality of forms.

In some forms, the fueling command may comprise a fuel injection command, the specified fuel quantity may comprise a specified fuel injection quantity, and the specified fuel pressure may comprise a specified fuel injection pressure. In such forms, the fuel injection command may be executable by a computing system to control a fuel injector to perform a fuel injection operation corresponding to (e.g., calculated, estimated, or otherwise determined to corresponded to) the specified fuel injection quantity and the specified fuel injection pressure.

In some forms, the fueling command may comprise a fuel pumping command, the specified fuel quantity may comprise a specified fuel pumping quantity, and the specified fuel pressure may comprise a specified fuel pumping pressure. In such forms, the fuel pumping command may be executable by a computing system to control a fuel pump to perform a fuel pumping operation corresponding to (e.g., calculated, estimated, or otherwise determined to corresponded to) the specified fuel pumping quantity and the specified fuel pumping pressure.

From operation 204, process 200 proceeds to operation 206 which determines a first fueling rate shape corresponding to the specified fuel pressure but not corresponding to the specified fuel quantity. For example, the first fueling rate shape may correspond to a maximum fueling quantity at the specified fuel pressure, while the specified fuel quantity may be less than the maximum fueling quantity. The first fueling rate shape may have a number of attributes and may be determined in a number of manners.

In some forms, the first fueling rate shape may comprise a fuel injection rate shape. The fuel injection rate shape may comprise a plurality of values indicating a fuel injection rate (fuel volume injected per unit time) as a function of time.

In some forms, the first fueling rate shape may comprise a fuel pumping rate shape. The fuel pumping rate shape may comprise a plurality of values indicating a fuel pumping rate (fuel volume pumped per unit time) as a function of time.

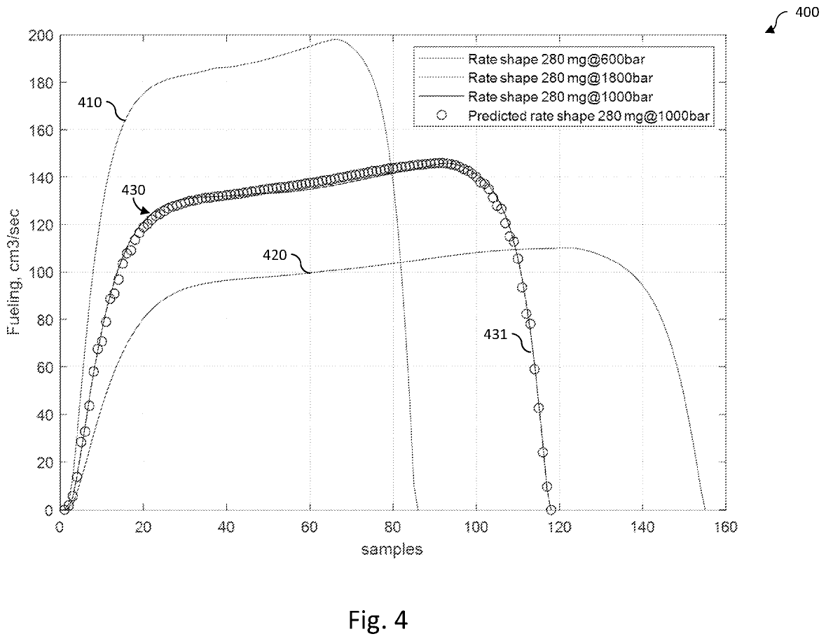

In some forms, the first fueling rate shape may be determined by interpolating between a first predetermined fueling rate shape for a predetermined fuel quantity differing from the specified fuel quantity and a first predetermined pressure differing from the specified fuel pressure and a second predetermined fueling rate shape for the predetermined fuel quantity and a second predetermined pressure differing from the specified fuel pressure. In some such forms the predetermined fuel quantity may comprise a predetermined fuel quantity, the first predetermined pressure may comprise an upper pressure, and the second predetermined pressure may comprise a lower pressure. In some such forms the predetermined fuel quantity may comprise a maximum fuel quantity, the first predetermined pressure may comprise a maximum pressure, and the second predetermined pressure may comprise a minimum pressure. Aspects of an example interpolation operation between a first predetermined fueling rate shape and a second predetermined fueling rate shape are illustrated and described in connection with FIG. 4.

From operation 206, process 200 proceeds to operations 207 which determine a second fueling rate shape corresponding to the specified fuel quantity and the specified fuel pressure. The second fueling rate shape may have a number of attributes and may be determined in a number of manners.

In some forms, the second fueling rate shape may comprise a fuel injection rate shape. The fuel injection rate shape may comprise a plurality of values indicating a fuel injection rate (fuel volume injected per unit time) as a function of time.

In some forms, the second fueling rate shape may comprise a fuel pumping rate shape. The fuel pumping rate shape may comprise a plurality of values indicating a fuel pumping rate (fuel volume pumped per unit time) as a function of time.

Operations 207 may comprise a number of operations utilized in determining a second fueling rate shape. In the illustrated embodiment, operations 207 include operation 208, operation 210, conditional 212, and operation 214. Other embodiments may include additional and/or alternative operations and conditionals which may be utilized in determining a second fueling rate shape.

In the illustrated embodiment, process 200 proceeds from operation 207 to operation 208 which may determine the second fueling rate shape at least in part by modifying the first fueling rate shape. In some such forms, operation 208 may modify the first fueling rate shape by repositioning a post-maximum fueling portion of the first fueling rate shape relative to a pre-maximum fueling portion of the first fueling rate shape. In some such forms, operation 208 may determine a maximum fueling point of an injection rate shape to identify or define a post-maximum fueling portion of the first fueling rate shape and a pre-maximum fueling portion of the first fueling rate shape.

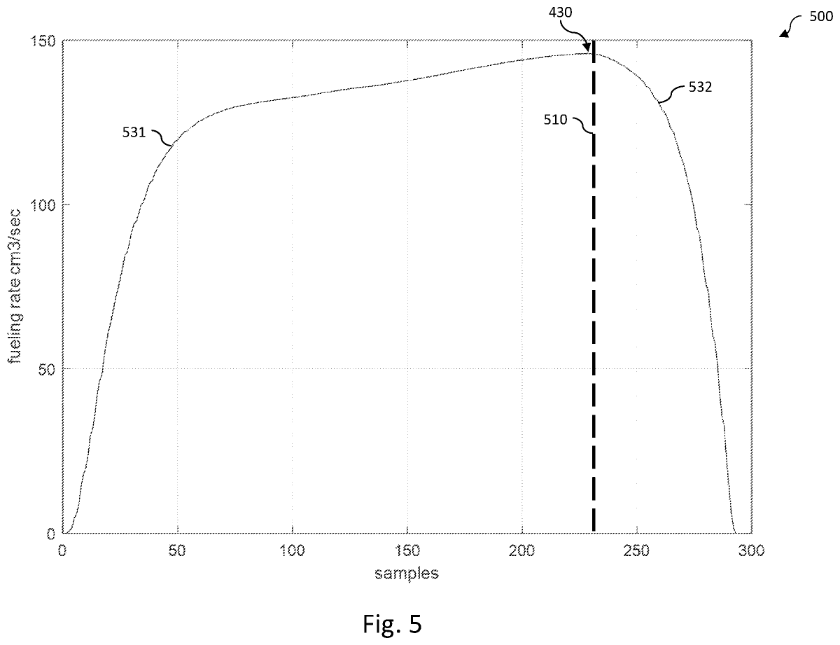

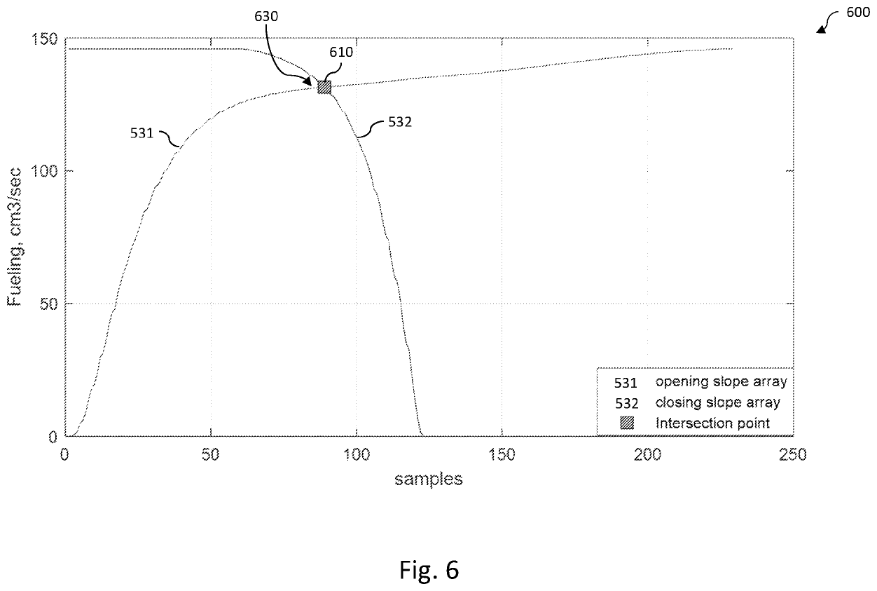

The fueling rate shape determined by operation 208 may be referred to as a modified first fueling rate shape or a modified fueling rate shape. The modified first fueling rate shape may in some instances serve as or comprise the second fueling rate shape or may provide a basis for further operations utilized by operations 207 in determining the second fueling rate shape. Aspects of an example fueling rate shape repositioning operation are illustrated and described in connection with FIGS. 5 and 6.

From operation 208, process 200 proceeds to operation 210 which evaluates a difference between the specified fuel quantity and the fuel quantity of the modified first fueling rate shape. Operation 210 may evaluates this difference in a number of manners. In some embodiments, operation 210 may integrate an area of the modified first fueling rate shape (e.g., am area under a rate shape curve) to determine a fuel quantity associated therewith and calculating a difference between the integrated area and the first specified fuel quantity.

From operation 210, process 200 proceeds to conditional 212 which evaluates whether the difference determined by operation 210 is greater than a difference criterion such as a limit or threshold. In the illustrated embodiment, conditional 212 evaluates whether the difference is greater than an upper limit (Lim_u) and whether the difference is less than a lower limit (Lim_l). Conditional 212 may utilize a logical OR operation which will evaluate affirmative if the difference is either greater than the upper limit or less than the lower limit.

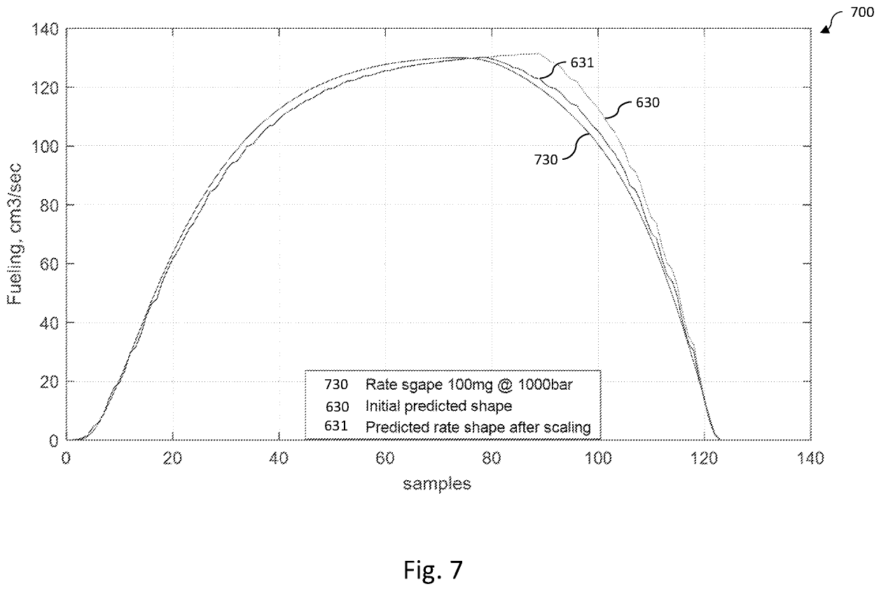

If conditional 212 evaluates affirmative, process 200 proceeds to operation 214 which further modifies at least the repositioned post-maximum fueling portion the modified first fueling rate shape. In some embodiments, operation 214 may further modify the repositioned post-maximum fueling portion the modified first fueling rate shape by performing a scaling operation effective to reduce the difference. Aspects of an example scaling operation are illustrated and described in connection with FIG. 7.

From operation 214, process 200 proceeds to operation 210 which operates as described above It shall be appreciated that the evaluating performed by conditional 212 and the scaling or other modification performed by operation 214 may be repeated multiple times until the resulting difference is not greater than the difference criterion.

If conditional 212 evaluates negative, process 200 proceeds to operation 216 which updates a fuel metering device control model based on the second fueling rate shape. The fuel metering device control model may have a number of attributes and may be updated in a number of manners.

In some embodiments, the fuel metering device control model may comprise a fuel injector control model configured to determine an injector operation command (e.g., an injector on-time or a start time, duration, and/or end time for injector operation). In such forms, the fuel injector control model may be implemented as one or more lookup tables configured to determine injector operation commands in response to inputs such as a fueling command.

In some embodiments, the fuel metering device control model may comprise a fuel pump control model configured to determine a pump operation command (e.g., a pump on-time or a start time, duration, and/or end time for pump operation). In such forms, the fuel pump control model may be implemented as one or more lookup tables configured to determine injector operation commands in response to inputs such as a fueling command.

From operation 216, process 200 proceeds to operation 218 which performs a fuel metering device operation. The fuel metering device operation may comprise one or both of controlling and diagnosing a fuel metering device of the fueling system using the updated fuel metering device control model. The fuel metering device operation may have a number of attributes and may be updated in a number of manners.

In some embodiments, the fuel metering device operation may comprise controlling a fuel injector to perform a fuel injection, for example, controlling one of fuel injectors 12 to inject fuel into a corresponding cylinder of engine 10. In some embodiment, the fuel metering device operation may additionally or alternatively comprise diagnosing operation of a fuel injector performing a fuel injection, for example, by comparing or evaluating a modified injection rate shape with a one or more predetermined criteria such as a nominal rate shape or other criteria.

In some embodiments, the fuel metering device operation may comprise controlling a fuel pump to perform a pumping operation, for example, controlling high-pressure pump 30 to pump fuel to common fuel rail 14. In some embodiment, the fuel metering device operation may additionally or alternatively comprise diagnosing operation of a fuel pump performing a fuel pumping operation, for example, by comparing or evaluating a modified injection rate shape with a one or more predetermined criteria such as a nominal rate shape or other criteria.

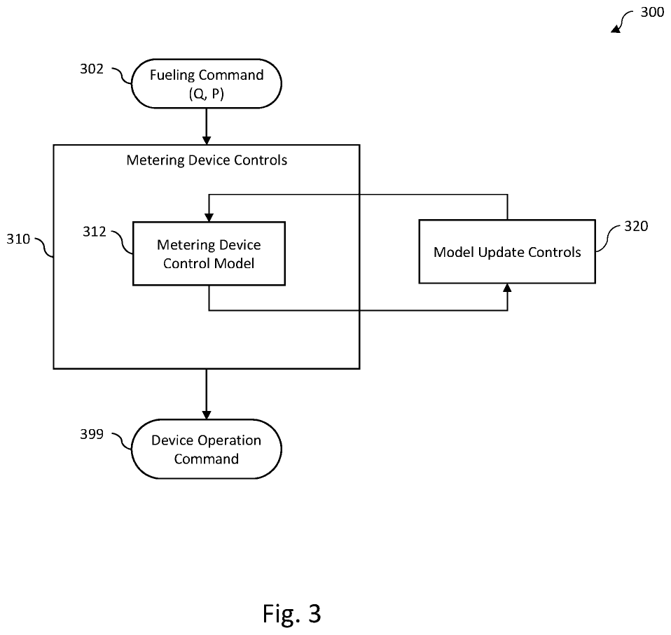

With reference to FIG. 3, there are illustrated example controls 300 which may be implemented in a computing system (e.g., ECS 20, another electronic control system, or another computing system) in operative communication with a fueling system (e.g., fueling system 9 or another fueling system). Controls 300 may be configured and operated to perform a process such as process 200.

Controls 300 include metering device controls 310 which are configured to receive a fueling command 302 and output a metering device operating command 399 in response to the fueling command 302. The fueling command 302 may include a fueling quantity and a fueling pressure. The metering device controls 310 may include a metering device control model 312 which is configured and operable to determine a metering device operating command 399 in response to the fueling command 302. Controls 300 further include a model update controls 320 which is adapted to update metering device control model 312, for example, as described in connection with process 200.

With reference to FIG. 4, there is illustrated a graph 400 depicting a first predetermined fueling rate shape 410 for a predetermined fuel quantity (280 mg) and a first predetermined pressure (1800 bar) and a second predetermined fueling rate shape 420 for the predetermined fuel quantity (280 mg) and a second predetermined pressure (600 bar). The y-axis of graph 400 indicates a fueling rate in units of cubic centimeters per second. The x-axis of graph indicates time in units of the number samples at a 40 kHz sampling rate.

Predetermined fueling rate shape 410 and predetermined fueling rate shape 420 may be determined empirically or calculated from a physics-based model stored in a data structure (e.g., a lookup table or other data strutted stored in a non-computer readable memory medium) prior to execution of a process such as process 200. A computing system executing a process such as process 200 may interpolate between predetermined fueling rate shape 410 and predetermined fueling rate shape 420 to determine values for predicted fueling rate shape 430 for the predetermined fuel quantity (280 mg) and a different pressure (1000 bar). The interpolation may be a linear interpolation, a piecewise linear interpolation or another type of interpolation.

Graph 400 also illustrates an actual injection rate shape 431 for the predetermined fuel quantity (280 mg) and the pressure of predicted fueling rate shape 430. It can be seen that there is a predicted fueling rate shape 430 corresponds to actual injection rate shape 431 with a high degree of accuracy and precision.

In the illustrated example, predetermined fueling rate shape 410, predetermined fueling rate shape 420, and predicted fueling rate shape 430 are predetermined injection rate shapes. It shall be appreciated that in other embodiments predetermined fueling rate shape 410, predetermined fueling rate shape 420, and predicted fueling rate shape 430 may be fuel pumping rate shapes or other types of fueling rate shapes and that the principles of the illustrated example are applicable mutatis mutandis fuel pumping rate shapes or other fueling rate shapes.

With reference to FIG. 5, there is illustrated a graph 500 depicting predicted fueling rate shape 430 and a maximum fueling point indicated by the intersection of line 510 and predicted fueling rate shape 430. The maximum fueling point may be determined by a process such as process 200 which may be performed by control such as controls 300.

Process 200 and/or controls 300 may utilize the maximum fueling point to define, determine, or identify post-maximum fueling portion 532 of the predicted fueling rate shape 430. Post-maximum fueling portion 532 may comprises an injector closing portion of predicted fueling rate shape 430 or a pump closing portion of predicted fueling rate shape 430.

Process 200 and/or controls 300 may utilize the maximum fueling point to define, determine, or identify pre-maximum fueling portion 531 of the predicted fueling rate shape 430. Pre-maximum fueling portion 531 may comprises an injector opening portion of predicted fueling rate shape 430 or a pump opening portion of predicted fueling rate shape 430.

With reference to FIG. 6, there is illustrated a graph 600 depicting a modified predicted fueling rate shape 630 which may be determined by a process such as process 200 which may be performed by control such as controls 300. Process 200 and/or controls 300 may determine modified predicted fueling rate shape 630 by repositioning a post-maximum fueling portion 532 of predicted fueling rate shape 430 relative to a pre-maximum fueling portion 531 of the predicted fueling rate shape 430. In the illustrated example, post-maximum fueling portion 532 is moved or transposed along the x-axis to a position where it intersects pre-maximum fueling portion 531 at intersection point 610. The repositioning may be performed based on a preexisting, pre-update metering device control model.

In some embodiments, the repositioning of post-maximum fueling portion 532 of predicted fueling rate shape 430 to intersection point 610 may use the specified fueling quantity of the fueling command received at operation 204 to compute an on-time (e.g., injector on-time or pump on-time) using a predetermined relationship between fueling quantity and on-time which may be stored, for example, by one or more predetermined tables or other data structures. An end of injection delay and a start of injection delay may also be computed, for example, based on predetermined information or monitoring of system operation. The computed on-time, end of injection delay, and start of injection delay may then be utilized to compute an actual hydraulic duration, for example, in accordance with the equation HD =OT +(EOI_delay SOI_delay), where HD is the hydraulic duration, OT is the on-time, EOI_delay is the end of injection delay, and SOI_delay is the start of injection delay.

With reference to FIG. 7, there is illustrated a graph 700 depicting modified predicted fueling rate shape 630 and further modification 631 thereof which may be determined by a process such as process 200 which may be performed by control such as controls 300. Process 200 and/or controls 300 may determine the rate shape of further modification 631 by scaling the modified predicted fueling rate shape 630. In some embodiments scaling the modified predicted fueling rate shape 630 may include calculating a scaling factor, for example, in accordance with the equation SF=(Q_cmd/Q_pred) where SF is a scaling factor which may be determined at or in connection with operation 210, Q_cmd is the specified fueling quantity of the fueling command received at operation 204, and Q_pred is the predicted fueling quantity obtained at operation 210.

As descried above, the further modification 631 may be determined in accordance with process 200 wherein a modified predicted fueling rate shape 630 is determined (e.g., in accordance with operation 208), a predicted quantity is determined and evaluated to determine whether an upper limit is exceeded or a lower limit is exceeded (e.g., in accordance with operation 210 and operation 212). If the upper limit is exceeded, further modification 631 may be determined by scaling down the post-maximum fueling portion 532 of the modified predicted fueling rate shape 630 using a scaling factor such as scaling factor SF with the intersection point 610 being moved to the left on graph 600. If the lower limit is exceeded, further modification 631 may be determined by scaling up the post-maximum fueling portion 532 of the modified predicted fueling rate shape 630 using a scaling factor such as scaling factor SF with the intersection point 610 being moved to the right on graph 600.

As shown by this detailed description, the present disclosure contemplates multiple and various embodiments, including, without limitation, the following example embodiments. A first example embodiment is process of operating a computing system in operative communication with a fueling system including, the process comprising: receiving a fueling command including a specified fuel quantity and a specified fuel pressure; determining a first fueling rate shape corresponding to the specified fuel pressure but not corresponding to the specified fuel quantity; determining a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape; updating a fuel metering device control model based on the second fueling rate shape; and at least one of controlling and diagnosing a fuel metering device of the fueling system using the updated fuel metering device control model.

A second example embodiment includes the features of the first example embodiment, wherein the determining the first fueling rate shape fueling rate shape comprises interpolating between a first predetermined fueling rate shape for a predetermined fuel quantity differing from the specified fuel quantity and a first predetermined pressure differing from the specified fuel pressure and a second predetermined fueling rate shape for the predetermined fuel quantity and a second predetermined pressure differing from the specified fuel pressure.

A third example embodiment includes the features of the second example embodiment, wherein the predetermined fuel quantity is a maximum fuel quantity, the first predetermined pressure is a maximum pressure, and the second predetermined pressure is a minimum pressure.

A fourth example embodiment includes the features of the first example embodiment, wherein the determining the second fueling rate shape further comprises: evaluating a difference between the specified fuel quantity and the fuel quantity of the modified first fueling rate shape having the post-maximum fueling portion repositioned relative to the pre-maximum fueling portion; and if the difference is greater than a difference criterion, modifying the post-maximum fueling closing portion to reduce the difference.

A fifth example embodiment includes the features of the fourth example embodiment, wherein the evaluating comprises integrating an area of the modified first fueling rate shape and calculating the difference between the integrated area and the specified fuel quantity.

A sixth example embodiment includes the features of the fourth example embodiment, and comprises repeating the evaluating and the modifying until the difference is not greater than the difference criterion.

A seventh example embodiment includes the features of any one of the first through sixth embodiments, wherein the fueling command comprises a fuel injection command, the specified fuel quantity comprises a specified injection quantity, the specified fuel pressure comprises a specified injection pressure, the first fueling rate shape comprises a first injection rate shape, the second fueling rate shape comprises a second injection rate shape, the fuel metering device control model comprises a fuel injector control model, the fuel metering device comprises a fuel injector, the post-maximum fueling portion of the first fueling rate shape comprises an injector closing portion of the first fueling rate shape, and the pre-maximum fueling portion of the first fueling rate shape comprises an injector opening portion of the first fueling rate shape.

An eighth example embodiment includes the features of the seventh example, embodiment, wherein the at least one of controlling and diagnosing a fuel metering device of the fueling system using the updated fuel metering device control model comprises determining an injector on-time to provide the specified fuel quantity and controlling a fuel injector in response to the injector on-time.

A ninth example embodiment includes the features of any one of the first through sixth embodiments, wherein the fueling command comprises a fuel pumping command, the specified fuel quantity comprises a specified pumping quantity, the specified fuel pressure comprises a specified pumping pressure, the first fueling rate shape comprises a first pumping rate shape, the second fueling rate shape comprises a second pumping rate shape, the fuel metering device control model comprises a fuel pump control model, the fuel metering device comprises a fuel pump, the post-maximum fueling portion of the first fueling rate shape comprises a pump closing portion of the first fueling rate shape, and the post-maximum fueling portion of the first fueling rate shape comprises a pump opening portion of the first fueling rate shape.

A tenth example embodiment includes the features of the seventh example embodiment, wherein the at least one of controlling and diagnosing a fuel metering device of the fueling system using the updated fuel metering device control model comprises determining a start-of-pumping time to provide the specified fuel quantity and controlling a fuel pump in response to the start-of-pumping time.

An eleventh example embodiment is a system comprising: a fueling system; and an electronic control system in operative communication with the fueling system and configured to: receive a fueling command including a specified fuel quantity and a specified fuel pressure; determine a first fueling rate shape corresponding to the specified fuel pressure but not corresponding to the specified fuel quantity; determine a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape; update a fuel metering device control model based on the second fueling rate shape; and one or both of control and diagnose a fuel metering device of the fueling system using the updated fuel metering device control model.

A twelfth example embodiment includes the features of the eleventh example embodiment, wherein the electronic control system being configured to determine the first fueling rate shape comprises the electronic control system being configured to interpolate between a first predetermined fueling rate shape for a predetermined fuel quantity differing from the specified fuel quantity and a first predetermined pressure differing from the specified fuel pressure and a second predetermined fueling rate shape for the predetermined fuel quantity and a second predetermined pressure differing from the specified fuel pressure.

A thirteenth example embodiment includes the features of the twelfth example embodiment, wherein the predetermined fuel quantity is a maximum fuel quantity, the first predetermined pressure is a maximum pressure, and the second predetermined pressure is a minimum pressure.

A fourteenth example embodiment includes the features of the eleventh example embodiment, wherein the electronic control system being configured to determine the second fueling rate shape comprises the electronic control system being configured to: evaluate a difference between the specified fuel quantity and the fuel quantity of the modified first fueling rate shape having the post-maximum fueling portion repositioned relative to the pre-maximum fueling portion; and if the difference is greater than a difference criterion, modify the post-maximum fueling closing portion to reduce the difference.

A fifteenth example embodiment includes the features of the fourteenth example embodiment, wherein the electronic control system being configured to evaluate the difference comprises the electronic control system being configured to integrate an area of the modified first fueling rate shape and calculate the difference between the integrated area and the specified fuel quantity.

A sixteenth example embodiment includes the features of the fourteenth example embodiment, wherein the electronic control system being configured to repeatedly evaluate the difference and modify the post-maximum fueling closing portion until the difference is not greater than the difference criterion.

A seventeenth example embodiment includes the features any one of the eleventh through sixteenth example embodiments, wherein the fueling command comprises a fuel injection command, the specified fuel quantity comprises a specified injection quantity, the specified fuel pressure comprises a specified injection pressure, the first fueling rate shape comprises a first injection rate shape, the second fueling rate shape comprises a second injection rate shape, the fuel metering device control model comprises a fuel injector control model, the fuel metering device comprises a fuel injector, the post-maximum fueling portion of the first fueling rate shape comprises an injector closing portion of the first fueling rate shape, and the pre-maximum fueling portion of the first fueling rate shape comprises an injector opening portion of the first fueling rate shape.

An eighteenth example embodiment includes the features of the seventeenth example embodiment, wherein the electronic control system being configured to one or both of control and diagnose the fuel metering device of the fueling system using the updated fuel metering device control model comprises the electronic control system being configured to determine an injector on-time to provide the specified fuel quantity and control a fuel injector in response to the injector on-time.

A nineteenth example embodiment includes the features of any one of the eleventh through sixteenth example embodiments, wherein the fueling command comprises a fuel pumping command, the specified fuel quantity comprises a specified pumping quantity, the specified fuel pressure comprises a specified pumping pressure, the first fueling rate shape comprises a first pumping rate shape, the second fueling rate shape comprises a second pumping rate shape, the fuel metering device control model comprises a fuel pump control model, the fuel metering device comprises a fuel pump, the post-maximum fueling portion of the first fueling rate shape comprises a pump closing portion of the first fueling rate shape, and the post-maximum fueling portion of the first fueling rate shape comprises a pump opening portion of the first fueling rate shape.

A twentieth example embodiment includes the features of the seventeenth example embodiment, wherein the electronic control system being configured to one or both of control and diagnose the fuel metering device of the fueling system using the updated fuel metering device control model comprises the electronic control system being configured to determine a start-of-pumping time to provide the specified fuel quantity and control a fuel pump in response to the start-of-pumping time.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to any of a number of acts, configurations, devices, operations, and techniques, individually or in combination, including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process of operating a computing system in operative communication with a fueling system including, the process comprising:
receiving a fueling command including a specified fuel quantity and a specified fuel pressure;
determining a first fueling rate shape corresponding to the specified fuel pressure but not corresponding to the specified fuel quantity;
determining a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape;
updating a fuel metering device control model based on the second fueling rate shape; and
at least one of controlling and diagnosing a fuel metering device of the fueling system using the updated fuel metering device control model.

2. The process of claim 1, wherein the determining the first fueling rate shape fueling rate shape comprises interpolating between a first predetermined fueling rate shape for a predetermined fuel quantity differing from the specified fuel quantity and a first predetermined pressure differing from the specified fuel pressure and a second predetermined fueling rate shape for the predetermined fuel quantity and a second predetermined pressure differing from the specified fuel pressure.

3. The process of claim 2, wherein the predetermined fuel quantity is a maximum fuel quantity, the first predetermined pressure is a maximum pressure, and the second predetermined pressure is a minimum pressure.

4. The process of claim 1, wherein the determining the second fueling rate shape further comprises:
evaluating a difference between the specified fuel quantity and the fuel quantity of the modified first fueling rate shape having the post-maximum fueling portion repositioned relative to the pre-maximum fueling portion; and
if the difference is greater than a difference criterion, modifying the post-maximum fueling closing portion to reduce the difference.

5. The process of claim 4, wherein the evaluating comprises integrating an area of the modified first fueling rate shape and calculating the difference between the integrated area and the specified fuel quantity.

6. The process of claim 4, comprising repeating the evaluating and the modifying until the difference is not greater than the difference criterion.

7. The process of claim 1, wherein
the fueling command comprises a fuel injection command,
the specified fuel quantity comprises a specified injection quantity,
the specified fuel pressure comprises a specified injection pressure,
the first fueling rate shape comprises a first injection rate shape,
the second fueling rate shape comprises a second injection rate shape,
the fuel metering device control model comprises a fuel injector control model,
the fuel metering device comprises a fuel injector,
the post-maximum fueling portion of the first fueling rate shape comprises an injector closing portion of the first fueling rate shape, and
the pre-maximum fueling portion of the first fueling rate shape comprises an injector opening portion of the first fueling rate shape.

8. The process of claim 7, wherein the at least one of controlling and diagnosing a fuel metering device of the fueling system using the updated fuel metering device control model comprises determining an injector on-time to provide the specified fuel quantity and controlling a fuel injector in response to the injector on-time.

9. The process of claim 1, wherein
the fueling command comprises a fuel pumping command,
the specified fuel quantity comprises a specified pumping quantity,
the specified fuel pressure comprises a specified pumping pressure,
the first fueling rate shape comprises a first pumping rate shape,
the second fueling rate shape comprises a second pumping rate shape,
the fuel metering device control model comprises a fuel pump control model,
the fuel metering device comprises a fuel pump,
the post-maximum fueling portion of the first fueling rate shape comprises a pump closing portion of the first fueling rate shape, and
the post-maximum fueling portion of the first fueling rate shape comprises a pump opening portion of the first fueling rate shape.

10. The process of claim 7, wherein the at least one of controlling and diagnosing a fuel metering device of the fueling system using the updated fuel metering device control model comprises determining a start-of-pumping time to provide the specified fuel quantity and controlling a fuel pump in response to the start-of-pumping time.

11. A system comprising:
a fueling system; and
an electronic control system in operative communication with the fueling system and configured to:
receive a fueling command including a specified fuel quantity and a specified fuel pressure;
determine a first fueling rate shape corresponding to the specified fuel pressure but not corresponding to the specified fuel quantity;
determine a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape;
update a fuel metering device control model based on the second fueling rate shape; and
one or both of control and diagnose a fuel metering device of the fueling system using the updated fuel metering device control model.

12. The system of claim 11, wherein the electronic control system being configured to determine the first fueling rate shape comprises the electronic control system being configured to interpolate between a first predetermined fueling rate shape for a predetermined fuel quantity differing from the specified fuel quantity and a first predetermined pressure differing from the specified fuel pressure and a second predetermined fueling rate shape for the predetermined fuel quantity and a second predetermined pressure differing from the specified fuel pressure.

13. The system of claim 12, wherein the predetermined fuel quantity is a maximum fuel quantity, the first predetermined pressure is a maximum pressure, and the second predetermined pressure is a minimum pressure.

14. The system of claim 11, wherein the electronic control system being configured to determine the second fueling rate shape comprises the electronic control system being configured to:
evaluate a difference between the specified fuel quantity and the fuel quantity of the modified first fueling rate shape having the post-maximum fueling portion repositioned relative to the pre-maximum fueling portion; and
if the difference is greater than a difference criterion, modify the post-maximum fueling closing portion to reduce the difference.

15. The system of claim 14, wherein the electronic control system being configured to evaluate the difference comprises the electronic control system being configured to integrate an area of the modified first fueling rate shape and calculate the difference between the integrated area and the specified fuel quantity.

16. The system of claim 14, wherein the electronic control system being configured to repeatedly evaluate the difference and modify the post-maximum fueling closing portion until the difference is not greater than the difference criterion.

17. The system of claim 11, wherein
the fueling command comprises a fuel injection command,
the specified fuel quantity comprises a specified injection quantity,
the specified fuel pressure comprises a specified injection pressure,
the first fueling rate shape comprises a first injection rate shape,
the second fueling rate shape comprises a second injection rate shape,
the fuel metering device control model comprises a fuel injector control model,
the fuel metering device comprises a fuel injector,
the post-maximum fueling portion of the first fueling rate shape comprises an injector closing portion of the first fueling rate shape, and
the pre-maximum fueling portion of the first fueling rate shape comprises an injector opening portion of the first fueling rate shape.

18. The system of claim 17, wherein the electronic control system being configured to one or both of control and diagnose the fuel metering device of the fueling system using the updated fuel metering device control model comprises the electronic control system being configured to determine an injector on-time to provide the specified fuel quantity and control a fuel injector in response to the injector on-time.

19. The system of claim 11, wherein
the fueling command comprises a fuel pumping command,
the specified fuel quantity comprises a specified pumping quantity,
the specified fuel pressure comprises a specified pumping pressure,
the first fueling rate shape comprises a first pumping rate shape,
the second fueling rate shape comprises a second pumping rate shape,
the fuel metering device control model comprises a fuel pump control model,
the fuel metering device comprises a fuel pump,
the post-maximum fueling portion of the first fueling rate shape comprises a pump closing portion of the first fueling rate shape, and
the post-maximum fueling portion of the first fueling rate shape comprises a pump opening portion of the first fueling rate shape.

20. The system of claim 17, wherein the electronic control system being configured to one or both of control and diagnose the fuel metering device of the fueling system using the updated fuel metering device control model comprises the electronic control system being configured to determine a start-of-pumping time to provide the specified fuel quantity and control a fuel pump in response to the start-of-pumping time.
